(19) United States
(12) Patent Application Publication
(10) Pub. No.: US 2003/0086838 A1
(43) Pub. Date: May 8, 2003

(54) Metal sheet with barrier for a honeycomb body and metallic honeycomb body

(76) Inventors: Rolf Bruck, Bergisch Gladbach (DE); Jutta Illerich, Linnich (DE)

Correspondence Address: LERNER AND GREENBERG, P.A., POST OFFICE BOX 2480, HOLLYWOOD, FL, 33022-2480, US

(21) Appl. No.: 10/310,928

(22) Filed: Dec. 5, 2002

Related U.S. Application Data
(63) Continuation of application No. PCT/EP01/05686, filed on May 18, 2001.

(30) Foreign Application Priority Data
Jun. 5, 2000 (DE) 100 27 807.8

(51) Int. Cl. B01D 53/74; F01N 3/28

(52) U.S. Cl. 422/180; 422/177

(57) ABSTRACT

A metal sheet, in particular for a honeycomb body of a catalytic converter, has a length, a width and first and second end surfaces. A barrier disposed at least in the vicinity of the first and/or second end surface runs at least partially parallel to the end surface, for the controlled or targeted prevention of a connection using a joining technique. The barrier is in the form of a coating. It is therefore possible, for example, to define a connection region for a plurality of metal sheets which are to be brazed together. Corrosion occurring as a result of a concentration of brazing material is thus prevented, in particular when using thin metal sheets. A metallic honeycomb body having the metal sheet is also provided.

### CROSS REFERENCE TO RELATED APPLICATION

This application is a continuation of copending International Application No. PCT/EP01/05686, filed May 18, 2001, which designated the United States and was not published in English.

### BACKGROUND OF THE INVENTION

### FIELD OF THE INVENTION

The invention relates to a metal sheet, in particular for a honeycomb body of a catalytic converter. Such catalytic converters are used in particular for cleaning an exhaust gas from an internal-combustion engine. The invention also relates to a metallic honeycomb body, in particular for a catalytic converter for cleaning an exhaust gas from an internal-combustion engine.

Catalytic converters that are constructed with sheet-metal layers which are at least partially structured in such a way that an exhaust gas can flow through them, are known. The sheet-metal layers are stacked and/or wound and disposed in a tubular jacket. The sheet-metal layers are then provided at end sides thereof with an adhesive which, due to a capillary action, penetrates into an interior of a honeycomb body of that type. The adhesive ensures that brazing material which is subsequently applied adheres to the sheet-metal layers and a permanent connection is formed between the sheet-metal layers.

In view of increasingly stringent exhaust guidelines and regulations, it is desirable for the catalytic converter to be heated rapidly after a cold start. Rapid heating of the catalytic converter is advantageous since the converter only begins chemical conversion of pollutants in the exhaust gas once it reaches a temperature of approximately 250° C. For that purpose, the catalytic converters are constructed with increasingly thin metal sheets, in order to reduce heat capacity of the catalytic converter.

European Patent Application 0 454 712 A1 has disclosed a metallic honeycomb body made from metal sheets. The metal sheets are at least partially provided with a macrostructure, which determines a honeycomb form and mechanical properties of the honeycomb body. Furthermore, the metal sheets are at least partially provided with a microstructure running transversely or at an angle to the direction of flow of the exhaust gas, in order to ensure thorough mixing of the flow.

The combination of macrostructure and microstructure may lead to metal sheets being spaced apart from one another in the region of the end surface of a metallic honeycomb body of that type. Consequently, in order to achieve a permanent connection between the sheet-metal layers, it is necessary for a size of grains of brazing material to bridge distances between the individual sheet-metal layers. However, the use of large grains of brazing material may lead to undesirable chemical reactions of locally concentrated brazing material with the thin metal sheets. By way of example, corrosion in combination with high thermal and dynamic stresses on the honeycomb body in an exhaust system may cause the metal sheets to fracture.

### SUMMARY OF THE INVENTION

It is accordingly an object of the invention to provide a metal sheet with a barrier for a honeycomb body and a metallic honeycomb body, which overcome the hereinafore-mentioned disadvantages of the heretofore-known devices of this general type and in which the metal sheet is suitable in particular for a honeycomb body of a catalytic converter and prevents a local concentration of brazing material during a brazing process and subsequent corrosion of metal sheets.

With the foregoing and other objects in view there is provided, in accordance with the invention, a metal sheet, in particular for a honeycomb body of a catalytic converter, comprising a length, a width, a first end surface and a second end surface. A barrier is disposed at least in the vicinity of the first and/or second end surface. The barrier extends at least partially parallel to the at least one end surface, for controlled prevention of a connection using a joining technique, and the barrier is a coating.

The barrier prevents brazing material from adhering to the metal sheet and thus delimits a region extending from the first and/or second end surface to the barrier in which the metal sheets are connected to one another using a joining technique. The configuration of the barrier in the vicinity of the first and/or second end surface depends on the end side from which the metal sheet is provided with adhesive and brazing material.

In accordance with another feature of the invention, the barrier is disposed at a distance of at most 5 mm, preferably at most 3 mm, from the first end surface and/or the second end surface. This means that only a small amount of brazing material adheres to the metal sheet and the connection between the metal sheets using a joining technique is restricted to at most 5 mm close to the at least one end side.

In accordance with a further feature of the invention, the barrier extends over the entire width of the metal sheet. This ensures that no brazing material enters a region which is further away from the corresponding end side than the barrier.

In accordance with an added feature of the invention, the barrier is constructed in the form of a coating which is an oxide layer. The oxide layer prevents the adhesion of brazing material. An oxide layer of this type may, for example, be produced by forming a ceramic layer and heating the metal sheet in the presence of an oxygen-containing gas or by a chemical reaction.

In accordance with an additional feature of the invention, the barrier is constructed as a coating including brazing stop. In this context, the term brazing stop is understood as meaning, for example, a substance which has ceramic constituents, binders and solvents. The brazing stop also prevents the flow of brazing material and in this way forms a barrier.

In accordance with yet another feature of the invention, there is provided at least one microstructure disposed between the first end surface and/or the second end surface and the barrier. This microstructure ensures contact between adjacent metal sheets when producing a honeycomb body, particularly when using honeycomb bodies made from metal sheets with microstructures in the interior of the honeycomb body. This microstructure forms capillaries through which an adhesive flows, ensuring adequate adhesion of brazing material. Accordingly, the length of the capillaries is limited by the form of the microstructure, thus ensuring that the connection region is accurately delimited.

In accordance with yet a further feature of the invention, the at least one microstructure extends over the entire width of the metal sheet. In particular, it is disposed in such a way that the distance from the corresponding end surface is constant over the entire width.

In accordance with yet an added feature of the invention, the at least one microstructure is constructed with a thickness which extends from the end surface to the barrier. Adjacent metal sheets of a metallic honeycomb body are connected to one another by using a joining technique only from the corresponding end surface to the barrier.

In this context and in accordance with yet an additional feature of the invention, the microstructure is constructed with a height of from 0.015 to 0.03 mm. Since this microstructure influences the through-flow of the exhaust gas while the catalytic converter is operating, the height of the microstructure is to be selected to be as small as possible, in order to prevent a high pressure loss across the catalytic converter.

In accordance with again another feature of the invention, the metal sheet is constructed with a sheet-metal thickness of less than 0.06 mm, preferably less than 0.03 mm. These very thin metal sheets are particularly sensitive with regard to a concentration of brazing material, making the use of a metal sheet with a barrier highly advantageous.

With the objects of the invention in view, there is also provided a metallic honeycomb body, in particular for a catalytic converter for cleaning an exhaust gas from an internal-combustion engine. The metallic honeycomb body comprises a first end side and a second end side, and sheet-metal layers at least partially structured to permit a fluid to flow through the honeycomb body. The sheet-metal layers include at least one metal sheet having a length, a width, a first end surface, a second end surface and a barrier disposed at least in the vicinity of the first and/or the second end surface. The barrier extends at least partially parallel to the at least one end surface, for controlled prevention of a connection using a joining technique. The barrier is a coating, and the at least one metal sheet is disposed in such a way that the barrier is placed close to and substantially parallel to one of the end sides.

In order to produce a honeycomb body of this type, the metal sheets according to the invention are, for example, stacked, wound and then inserted into a tubular jacket. All of the metal sheets with a barrier are disposed in such a way that they are aligned with the barrier toward that end side of the honeycomb body to which an adhesive and/or the brazing material is subsequently applied. In this way, a connection region which is disposed close to that end side of the honeycomb body which is to be brazed and is delimited by the barriers of the metal sheets, is defined.

In accordance with another feature of the invention, the sheet-metal layers are constructed as substantially smooth and corrugated metal sheets and the smooth metal sheets are constructed with a barrier. This facilitates production of the barrier, since it does not have to be formed on a corrugated surface and it is also not necessary for the barrier to withstand subsequent deformation to form the corrugated metal sheets.

In accordance with a further feature of the invention, the sheet-metal layers are connected to one another using a joining technique on at least one end side and in an adjoining connection region, and the connection region is delimited by the barrier of the metal sheets. The connection which uses a joining technique is preferably produced by using a high-temperature vacuum brazing process.

Other features which are considered as characteristic for the invention are set forth in the appended claims.

Although the invention is illustrated and described herein as embodied in a metal sheet with a barrier for a honeycomb body and a metallic honeycomb body, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, partly sectional, plan view of a metal sheet according to the invention;

FIG. 2 is a perspective view of a plurality of metal sheets according to the invention having a microstructure; and

FIG. 3 is an enlarged, sectional view of an embodiment of a metallic honeycomb body, which is taken along a line III-III of FIG. 2, in the direction of the arrows.

### DESCRIPTION OF THE PREFERRED EMBODIMENTS

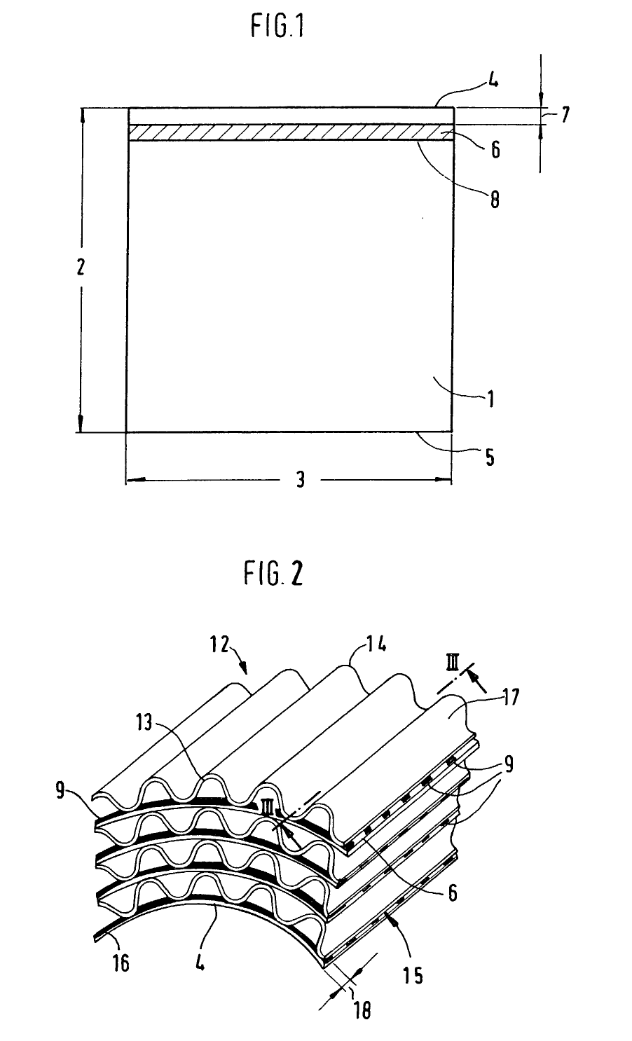

Referring now to the figures of the drawings in detail and first, particularly, to FIG. 1 thereof, there is seen a diagrammatic depiction of an embodiment of a metal sheet 1 according to the invention. The metal sheet 1 is particularly suitable for a honeycomb body 12 of a catalytic converter as shown in FIG. 2. The metal sheet has a length 2, a width 3 and, in addition, a first end surface 4 and a second end surface 5. The metal sheet 1 has a barrier 6 in the vicinity of the first end surface 4, which runs parallel to the end surface 4, for the controlled or targeted prevention of a connection using a joining technique. The barrier 6 is disposed at a distance 7 from the first end surface 4. The distance 7 is at most 5 mm and preferably at most 3 mm. The barrier 6 extends over the entire width 3 of the metal sheet 1 and has a coating 8 which is constructed, for example, as an oxide layer.

FIG. 2 shows a perspective view of a plurality of sheet-metal layers 15 of the honeycomb body 12 which are composed of smooth sheet-metal layers 16 and corrugated sheet-metal layers 17. The smooth sheet-metal layers 16 have a microstructure 9 which is suitable for thorough mixing of an exhaust gas that flows through the sheet-metal layers. One microstructure 9 of each smooth sheet-metal layer 16 is disposed in the vicinity of a first end side 13 of the honeycomb body, thus defining a connection region 18. Contact between the smooth sheet-metal layers 16 and the corrugated sheet-metal layers 17 is ensured in the connection region 18. An adhesive applied from the first end side 13 flows inside capillaries which are formed. The flow of the adhesive is interrupted when the adhesive has reached the barrier 6.

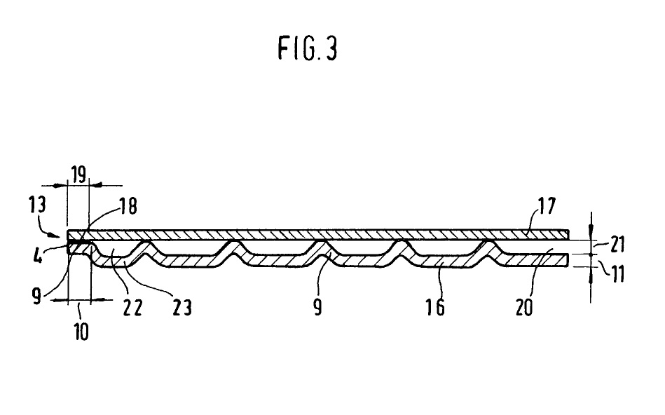

FIG. 3 diagrammatically depicts a longitudinal section taken along a contact region between a corrugated sheet-metal layer 17 and a smooth sheet-metal layer 16, as is indicated by a section line III-III shown in FIG. 2. The smooth sheet-metal layer 16 has a plurality of microstructures 9 with a height 21 which is suitable for thorough mixing of the exhaust gas. In the vicinity of a first end surface 4 or the first end side 13, the smooth metal sheet 16 has a microstructure 9 with a thickness 10 which corresponds to an extent 19 of the connection region 18 between the corrugated sheet-metal layer 17 and the smooth sheet-metal layer 16. The microstructure 9, in the vicinity of the first end side 13, bridges a gap 20 which is formed between the corrugated sheet-metal layer 17 and the smooth sheet-metal layer 16, for example, as a result of further microstructures 9 that are required for thorough mixing of the exhaust gas. The microstructure 9 is adjoined by a depression 23 which, in combination with the microstructure 9, forms a cavity 22 between the sheet-metal layers. The barrier 6, which is constructed as the depression 23, thus prevents a connection in the connection region 18 using a joining technique over the extent 19.

In this way, it is possible to use a fine-grained brazing material, in order to ensure a permanent connection between the sheet-metal layers, even with sheet-metal layers having a very small sheet-metal layer thickness 11.

What is claimed is:

1. A metal sheet, comprising:
a length, a width, a first end surface and a second end surface; and
a barrier disposed at least in the vicinity of at least one of said end surfaces, said barrier extended at least partially parallel to said at least one end surface, for controlled prevention of a connection using a joining technique, and said barrier being a coating.

2. The metal sheet according to claim 1, wherein said barrier is disposed at a distance of at most 5 mm from at least one of said end surfaces.

3. The metal sheet according to claim 1, wherein said barrier is disposed at a distance of at most 3 mm from at least one of said end surfaces.

4. The metal sheet according to claim 1, wherein said barrier extends entirely over said width.

5. The metal sheet according to claim 1, wherein said barrier coating is an oxide layer.

6. The metal sheet according to claim 1, wherein said barrier coating is made with a brazing stop.

7. The metal sheet according to claim 1, including at least one microstructure disposed between at least one of said end surfaces and said barrier.

8. The metal sheet according to claim 7, wherein said at least one microstructure extends entirely over said width.

9. The metal sheet according to claim 7, wherein said at least one microstructure has a thickness measured from said at least one end surface to said barrier.

10. The metal sheet according to claim 7, wherein said at least one microstructure has a height of 0.015 to 0.03 mm.

11. The metal sheet according to claim 1, including a metal-sheet thickness of less than 0.06 mm.

12. The metal sheet according to claim 1, including a metal-sheet thickness of less than 0.03 mm.

13. A metal sheet for a honeycomb body of a catalytic converter, the metal sheet, comprising:
a length, a width, a first end surface and a second end surface; and
a barrier disposed at least in the vicinity of at least one of said end surfaces, said barrier extended at least partially parallel to said at least one end surface, for controlled prevention of a connection using a joining technique, and said barrier being a coating.

14. A metallic honeycomb body, comprising:
a first end side and a second end side; and
sheet-metal layers at least partially structured to permit a fluid to flow through the honeycomb body;
said sheet-metal layers including at least one metal sheet having a length, a width, a first end surface, a second end surface and a barrier disposed at least in the vicinity of at least one of said end surfaces, said barrier extended at least partially parallel to said at least one end surface, for controlled prevention of a connection using a joining technique, said barrier being a coating, and said barrier disposed close to and substantially parallel to one of said end sides.

15. The metallic honeycomb body according to claim 15, wherein said sheet-metal layers include substantially smooth metal sheets and corrugated metal sheets, and said substantially smooth metal sheets have said barrier.

16. The metallic honeycomb body according to claim 15, wherein said sheet-metal layers are connected to one another by a joining technique at least at one of said end sides and in an adjoining connection region, and said connection region is delimited by said barrier.

17. A metallic honeycomb body for a catalytic converter used for cleaning an exhaust gas from an internal-combustion engine, the metallic honeycomb body, comprising:
a first end side and a second end side; and
sheet-metal layers at least partially structured to permit a fluid to flow through the honeycomb body;
said sheet-metal layers including at least one metal sheet having a length, a width, a first end surface, a second end surface and a barrier disposed at least in the vicinity of at least one of said end surfaces, said barrier extended at least partially parallel to said at least one end surface, for controlled prevention of a connection using a joining technique, said barrier being a coating, and said barrier disposed close to and substantially parallel to one of said end sides.
